(19) United States
(12) Patent Application Publication
(10) Pub. No.: US 2013/0293420 A1
(43) Pub. Date: Nov. 7, 2013

(54) TECHNIQUES FOR MAXIMIZING THE SIZE OF AN ANTENNA ARRAY PER RADIO MODULE

(71) Applicant: WILOCITY LTD., Caesarea (IL)

(72) Inventor: Alon YEHEZKELY, Haifa (IL)

(73) Assignee: WILOCITY LTD., Caesarea (IL)

(21) Appl. No.: 13/729,553

(22) Filed: Dec. 28, 2012

Related U.S. Application Data
(60) Provisional application No. 61/643,438, filed on May 7, 2012.

(51) Int. Cl. H01Q 21/06; H01Q 3/00

(52) U.S. Cl. CPC H01Q 21/061; H01Q 3/00
USPC 342/372; 343/844

(57) ABSTRACT

An active antenna array of a millimeter-wave radio frequency (RF) module is disclosed. The active antenna array comprises a multilayer substrate having at least a front layer, a back layer, and a plurality of middle layers; a first antenna sub-array implemented in the front layer; a second antenna sub-array implemented in the back layer; and a plurality of middle antenna sub-arrays implemented in the plurality of the middle layers, wherein each of the first antenna, the second antenna, and the plurality of middle antenna sub-arrays is configured to radiate millimeter-wave signals at a different direction.

### CROSS-REFERENCE TO RELATED APPLICATIONS

This application claims the benefit of US provisional application No. 61/643,438 filed on May 7, 2012, the contents of which are herein incorporated by reference.

### TECHNICAL FIELD

The present invention generally relates to millimeter wave radio frequency (RF) systems, and more particularly to efficient design of radio modules that increase the number of antennas per module.

### BACKGROUND

The 60 GHz band is an unlicensed band which features a large amount of bandwidth and a large worldwide overlap. The large bandwidth means that a very high volume of information can be transmitted wirelessly. As a result, multiple applications, each requiring transmission of large amounts of data, can be developed to allow wireless communication around the 60 GHz band. Examples for such applications include, but are not limited to, wireless high definition TV (HDTV), wireless docking stations, wireless Gigabit Ethernet, and many others.

In order to facilitate such applications there is a need to develop integrated circuits (ICs), such as amplifiers, mixers, radio frequency (RF) analog circuits, and active antennas that operate in the 60 GHz frequency range. An RF system typically comprises active and passive modules. The active modules (e.g., a phased array antenna) require control and power signals for their operation, which are not required by passive modules (e.g., filters). The various modules are fabricated and packaged as radio frequency integrated circuits (RFICs) that can be assembled on a printed circuit board (PCB). The size of the RFIC package may range from several to a few hundred square millimeters.

In the consumer electronics market, the design of electronic devices, and thus RF modules integrated therein, should meet the constraints of minimum cost, size, power consumption, and weight. The design of the RF modules should also take into consideration the current assembled configuration of electronic devices, and particularly handheld devices, such as laptop and tablet computers, in order to enable efficient transmission and reception of millimeter wave signals. Furthermore, the design of the RF module should account for minimal power loss of receive and transmit RF signals and for maximum radio coverage.

A schematic diagram of a RF module 100 designed for transmission and reception of millimeter wave signals is shown in FIG 1. The RF module 100 includes an array of active antennas 110-1 through 110-N connected to a RF circuitry or IC 120. Each of the active antennas 110-1 through 110-N may operate as transmit (TX) and/or receive (RX) antennas. An active antenna can be controlled to receive/transmit radio signals in a certain direction, to perform beam forming, and for switching from receive to transmit modes. For example, an active antenna may be a phased array antenna in which each radiating element can be controlled individually to enable the usage of beam-forming techniques.

In the transmit mode, the RF circuitry 120 typically performs up-conversion, using a mixer (not shown in FIG. 1), to convert intermediate frequency (IF) signals to radio frequency (RF) signals. Then, the RF circuitry 120 transmits the RF signals through the TX antenna according to the control signal. In the receive mode, the RF circuitry 120 receives RF signals through the active RX antenna and performs down-conversion, using a mixer, to IF signals using the local oscillator (LO) signals, and sends the IF signals to a baseband module (not shown in FIG. 1).

In both receive and transmit modes, the operation of the RF circuitry 120 is controlled by the baseband module using a control signal. The control signal is utilized for functions, such as gain control, RX/TX switching, power level control, beam steering operations, and so on. In certain configurations, the baseband module also generates the LO and power signals and transfers such signals to the RF circuitry 120. The power signals are DC voltage signals that power the various components of the RF circuitry 120. Normally, the IF signals are also transferred between the baseband module and the RF circuitry 120.

In common design techniques, the array of active antennas 110-1 to 110-N are implemented on the substrate upon which the IC of the RF circuitry 120 is also mounted. An IC is fabricated on a multi-layer substrate and metal vias that connect between the various layers. The multi-layer substrate may be a combination of metal and dielectric layers and can be made of materials, such as a laminate (e.g., FR4 glass epoxy, Bismaleimide-Triazine), ceramic (e.g., low temperature co-fired ceramic LTCC), polymer (e.g., polyimide), PTFE (Polytetrafluoroethylene) based compositions (e.g., PTFE/Ceramic, PTFE/Woven glass fiber), and Woven glass reinforced materials (e.g., woven glass reinforced resin), wafer level packaging, and other packaging, technologies and materials. The cost of the multi-layer substrate is a function of the area of the layer; the greater the area of the layer, the greater the cost of the substrate.

Antenna elements of the array of active antennas 110-1 to 110-N are typically implemented by having metal patterns in a multilayer substrate. Each antenna element can utilize several substrate layers. In conventional implementations for millimeter wave communications, antenna elements are designed to occupy a single side of the multi-layer substrate side. This is performed in order to allow the antenna radiation to properly propagate.

For example, a RF module 200 depicted in FIG. 2 includes a multi-layer substrate 210 and a plurality of antenna elements 220 implemented on an upper layer of the substrate 210. The antenna elements 220 are connected to a RF circuitry 230 using traces 201. The RF circuitry 230 performs the function discussed in greater detail above. The RF module 200 may also contain discrete electronic components 240, such as an antenna interface in an implementation of chip-board transition structure, which typically includes the IC (chip) package and transmission lines from the IC to the substrate. Additionally, circuits designed for impedance matching and electrostatic discharge (ESD) protection may be also part of the antenna interface.

The conventional RF designs require implementing the number of active antennas on one side of the substrate, thus providing a constraint that limits the number of antennas of the RF module. An attempt to increase the number of active antennas would require increasing the area of substrate. Also, such an attempt would require increasing the length of the wires (traces) from the RF circuitry to the antenna elements. Furthermore, simply increasing the number of antenna elements on one side of the multi-layer substrate would limit the performance of the RF module, and may not meet the constraints of an efficient design. Such constraints necessitate that the physical dimensions, the power consumption, heat transfer, and cost should be as minimal possible.

It would be therefore advantageous to provide an efficient IC layout design for an antenna array connectivity that overcomes the disadvantages of conventional layout design.

### SUMMARY

Certain embodiments disclosed herein include an active antenna array of a millimeter-wave radio frequency (RF) module. The module comprises a multilayer substrate having at least a front layer, a back layer, and a plurality of middle layers; a first antenna sub-array implemented in the front layer; a second antenna sub-array implemented in the back layer; and a plurality of middle antenna sub-arrays implemented in the plurality of the middle layers, wherein each of the first antenna, the second antenna, and the plurality of middle antenna sub-arrays is configured to radiate millimeter-wave signals at a different direction.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a diagram illustrating a RF module with an array of active antennas.

FIG. 2 is a diagram illustrating the assembly of a RF module and a plurality of antenna elements on a multi-layer substrate.

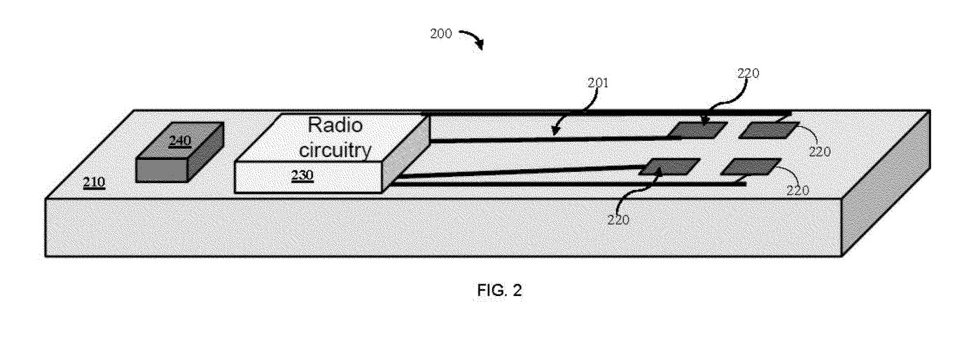

FIG. 3 is a diagram illustrating a radiation pattern of a RFIC constructed according to one embodiment.

FIG. 4 is a cross-section diagram of the RFIC illustrating the arrangement of the antenna arrays according to one embodiment.

FIG. 5 is a diagram illustrating an arrangement of the antenna array in the back layer of the substrate according to one embodiment.

FIG. 6 is a diagram illustrating an arrangement of the antenna array in a middle layer of a multi-layer substrate according to one embodiment.

FIG. 7 is a graph illustrating the coverage of the antenna array arranged in a RFIC according to one embodiment.

### DETAILED DESCRIPTION

The embodiments disclosed are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

According to various embodiments disclosed herein to improve the radio coverage of the millimeter wave radio module, multiple antenna arrays are utilized and arranged in the RF module in such a way that the area of the RF module is minimized. With this aim, in one embodiment, six different sub-arrays of antennas comprise the active antenna array of the RF module. The sub-arrays are utilized and arranged on a multi-layer substrate in such way that each sub-array of antennas radiates toward a different direction.

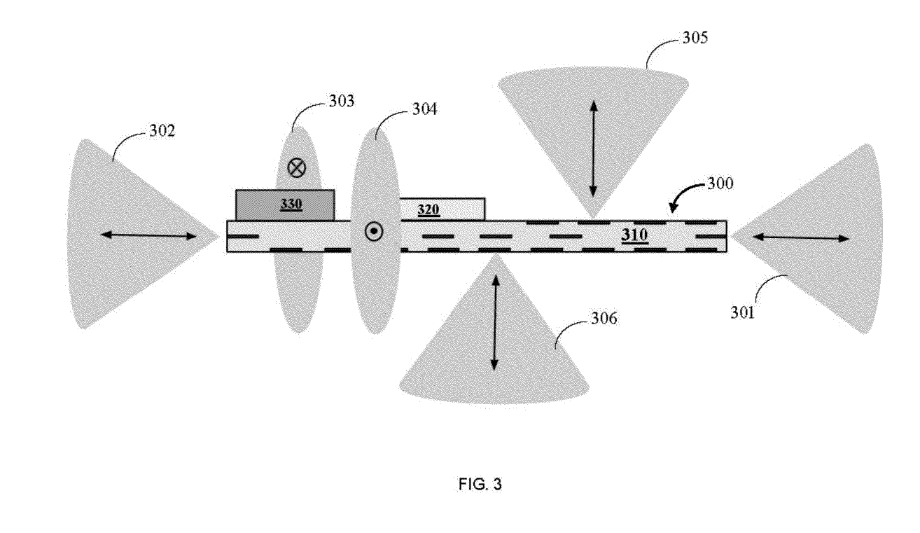

FIG. 3 semantically illustrates the radiation patterns of a RF module 300 constructed according to one embodiment. The RF module 300 packages at least the six antenna sub-arrays (not labeled in FIG. 3), an RF circuitry (e.g., in a form of IC) 320, and discrete electronic components 330 all fabricated on a multilayer substrate 310 of the RF module 300. The sub-array of antennas that form the active antenna array of the module 300 are designed to receive and transmit millimeter wave signals that propagate from four sides, 301, 302, 303, and 304 of the RF module 300. In addition, signals can propagate upward through the upper surface 305 of the RF module 300 and downward through the bottom surface 306 of the RF module 300.

In one embodiment, the RF module 300 is installed in electronic devices to provide millimeter wave applications of the 60 GHz frequency band. Examples for such applications include wireless docketing, wireless video transmission, wireless connectivity to storage appliances, and the like. The electronic devices may include, for example, smart phones, mobile phones, tablet computers, laptop computers, and the like.

According to one embodiment, each antenna array can be independently controlled by the RF circuitry 320. As a result, signals can be received and/or transmitted through any combination of the six antenna sub-arrays in the RF module 300, thus from any combination of directions. For example, only the antenna sub-arrays in the upper and bottom layers of the substrate 310 can be activated to allow reception and transmission of signals through upward and downward direction, and so on. As will be described below each radiating element in any of the antenna sub-arrays can be independently controlled to further improve and optimize the antenna array in the module 300. It should be noted that each antenna sub-array is configured to transmit and receive millimeter wave signals.

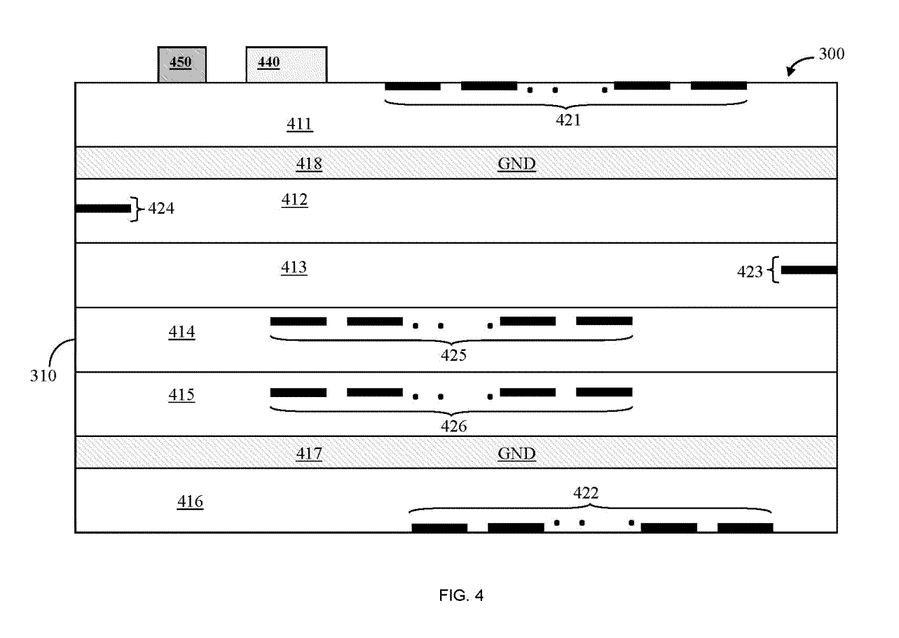

FIG. 4 shows a cross-section diagram of the RF module 300 illustrating the arrangement of the antenna arrays according to one embodiment. As illustrated in FIG. 4, the multi-layer substrate 310 of the RF module 300 contains six antenna sub-arrays 421, 422, 423, 424, 425, and 426 which comprise the active antenna array of the module and are implemented on different layers of the multi-layer substrate 310. The exemplary multi-layer substrate 310 include 8 layers 411 through 418, each such layer includes sub-layers of dialectic, metal and semiconductor materials that adhere to each other.

Specifically, the antenna sub-array 421 is implemented (e.g., printed or fabricated) on a front layer 411 of the substrate 310 and radiates at an upward direction (305). The antenna sub-array 422 is implemented in the back layer 416 of the substrate 310 and radiates at a downward direction (306). The antenna sub-arrays 423, 424, 425, and 426 are implemented in any middle layer of the 412, 413, 414, and 415 of the substrate 310. In one embodiment, each of the antenna sub-arrays 423, 424, 425, and 426 are implemented at a different layer of the middle layers 412, 413, 414, and 415. In another embodiment, two or more of the antenna sub-arrays 423, 424, 425, and 426 can share the same layer of the middle layers 412, 413, 414, and 415. In an exemplary configuration, antenna sub-arrays 423, 424, 425, and 426 radiate through sides 301, 302, 303, and 304 of the RF module 300 respectively. In the semantic diagram shown in FIG. 4, layers 417 and 418 are ground layers of the RF module 300. In one embodiment, all antenna sub-arrays share the ground layers 417 and 418. This allows the RF module 300 to maintain a compact stack-up and to shorten the vertical signal routing, thereby reducing the signal losses through the various antenna arrays.

Each of the antenna sub-arrays 421, 422, 423, 424, 425, and 426 can be an active antenna, such as a phased array antenna in which each radiating element can be controlled individually to enable the usage of beam-forming techniques. In addition, the active antenna may be a phased array antenna in which each radiating element can be controlled individually to enable the usage of beam-forming techniques. In a particular embodiment, each of the antenna sub-arrays 421, 422, 423, 424, 425, and 426 can be utilized to receive and transmit millimeter wave signals in the 60 GHz frequency band. As will be described in detail below the radiating elements of the “side” antenna sub-arrays 423, 424, 425, and 426 are constructed differently than the radiating elements of the antenna sub-arrays 421 and 422 of the front and back layers (411, 416).

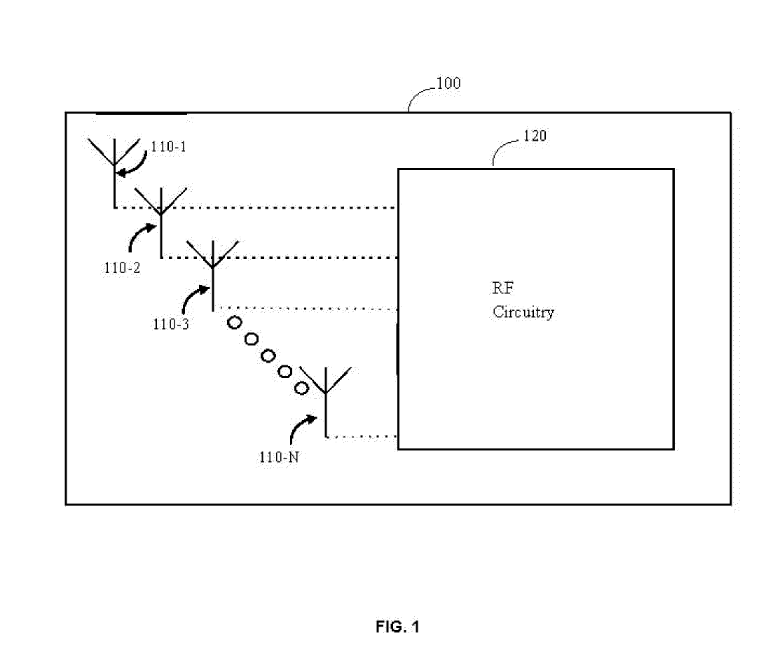

As depicted in FIG. 4, also implemented on the multi-layer substrate 310 is the RF circuitry (RFIC) 440 and discrete electronic components 450. The RF circuitry 440 typically performs up-conversion, using a mixer (not shown in FIG. 1), to convert intermediate frequency (IF) signals to radio frequency (RF) signals. Then, the RF circuitry 440 transmits the RF signals through the TX antenna according to the control of the control signal. In the receive mode, the RF circuitry 440 receives RF signals through the active RX antenna and performs down-conversion, using a mixer, to IF signals using the local oscillator (LO) signals, and sends the IF signals to a baseband module. In addition, according to one embodiment, the RF circuitry 440 can control the antenna sub-arrays 421, 422, 423, 424, 425, and 426 independently of each other. This allows achieving higher antenna diversity and optimal coverage at a specific direction. For example, the RF circuitry 440 can switch on the antenna sub-array 421, while switching off the other antenna arrays, and/or switching on the side antenna arrays, and so on. It should be noted that in addition to independently and individually controlling each antenna sub-array, the radiating elements in each antenna sub-array can also be independently controlled. The RF circuitry 440 also controls the phase per antenna in order to establish the beam-forming operation for the phased array antenna.

The discrete electronic components 450 include the components described above. In one embodiment, the RF circuitry 440 components 450 are packaged inside a metal shield (not shown) of the RF module 300. The metal shield adheres to the front layer 411, thus the RF circuitry 440 components 450 are also mounted on the front layer. It should be appreciated that the arrangement of the antenna sub-arrays 421-426 enable maximizing the number of antennas, and thereby the size of the active antenna array in a millimeter wave RF module, without increasing the area of the RF module, and thus the multi-layer substrate of the RF module.

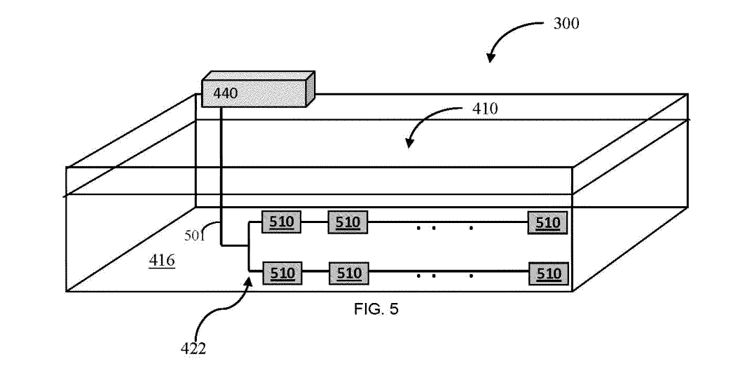

FIG. 5 shows an exemplary and non-limiting diagram of an arrangement of the antenna sub-array 422 in the back layer 416. The antenna sub-array 422 includes N radiating elements (collectively labeled as 510) arranged in two rows. In an exemplary embodiment the distance between each radiating element in the same sub-array is typically between a half wavelength and a full wavelength. In exemplary embodiments, the number N of the radiating elements may be an integer number, e.g., may be 2-7, 8, 16 and 32. The connections between the radiating elements 510 and the RF circuitry 440 are by means of traces 501 being routed through metal vias in the substrate 410. The radiating elements 510 are designed to support efficient reception and transmission of millimeter wave signals, particularly in the frequency band of 60 GHz.

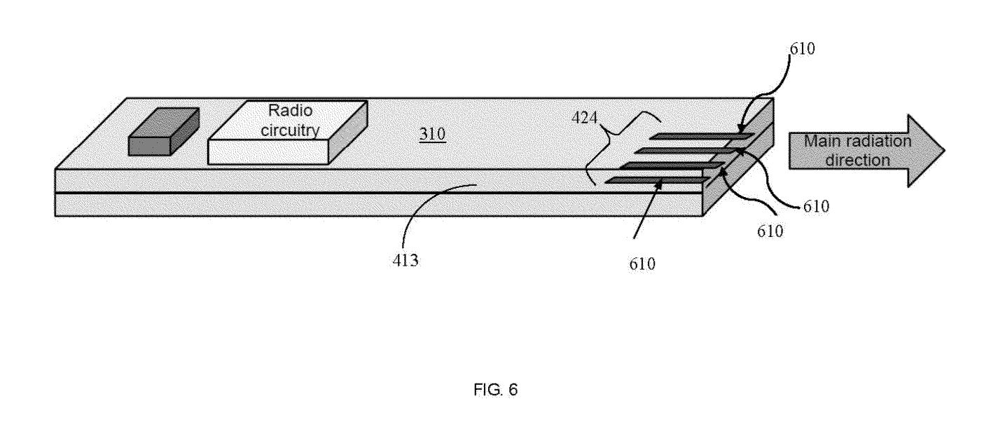

FIG. 6 shows an exemplary and non-limiting diagram illustrating the arrangement of the side antenna sub-array, in one of the middle layers of the multi-layer substrate 310. As noted above, each of the antenna sub-arrays 423, 424, 425, and 426 are implemented in the middle layers of a multilayer substrate. In the exemplary FIG. 6, the arrangement of the antenna sub-array 424 is depicted; however, it should be noted that same arrangement is utilized for each of the antenna sub-arrays 423, 425, and 426.

The antenna sub-array 424 includes a number of N radiating elements (collectively labeled as 610) arranged on the edge of one of the middle layers (413) of the substrate 310. In an embodiment disclosed herein the elements 610 are end-fire antenna elements which radiate mainly to the narrow sides of the module and are located on the edges of the substrate layers. The distance between two radiating elements is between a half wavelength and a full wavelength. The radiating elements 610 are designed to support efficient reception and transmission of millimeter wave signals, in particular in the frequency band of 60 GHz.

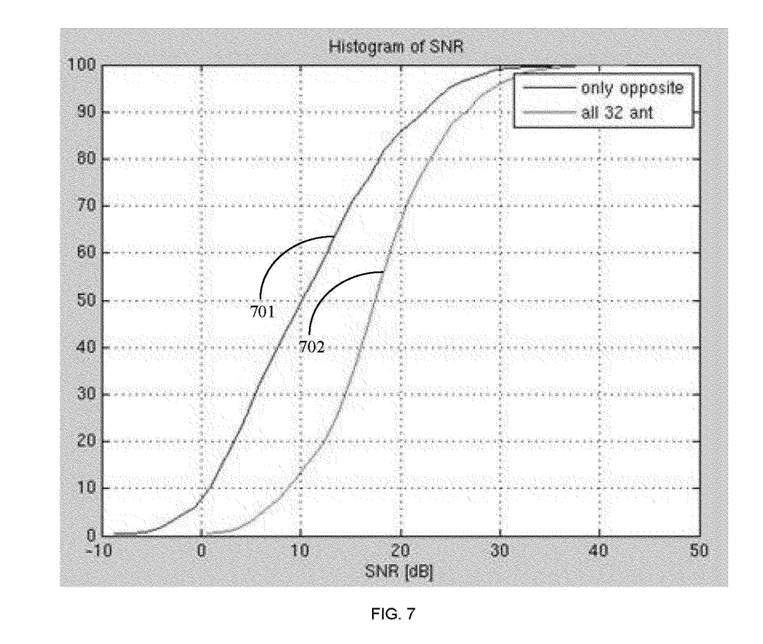

FIG. 7 is a graph of the cumulative distribution function (CDF) illustrating the probability of receiving a certain signal-to-noise ratio (SNR) in a number of locations in the space. The simulation was performed in a typical conference room. The graph 701 represents the coverage of the active antenna array consisting of the antenna sub-arrays 421 through 426, when using only the sub-array 421 on the front layer. The graph 702 represents the coverage when using all the sub-arrays arranged in an RFIC according to the embodiments disclosed in detail above. As can be noticed there is a gain improvement of 8-9 dB when using all of the antenna arrays.

It is important to note that these embodiments are only examples of the many advantageous uses of the innovative teachings herein. Specifically, the innovative teachings disclosed herein can be adapted in any type of consumer electronic device where reception and transmission of millimeter wave signals is needed. Moreover, some statements may apply to some inventive features but not to others. In general, unless otherwise indicated, it is to be understood that singular elements may be in plural and vice versa with no loss of generality.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An active antenna array of a millimeter-wave radio frequency (RF) module, comprising:
a multilayer substrate having at least a front layer, a back layer, and a plurality of middle layers;
a first antenna sub-array implemented in the front layer;
a second antenna sub-array implemented in the back layer; and
a plurality of middle antenna sub-arrays implemented in the plurality of the middle layers, wherein each of the first antenna sub-array, the second antenna sub-array, and the plurality of middle antenna sub-arrays is configured to radiate millimeter-wave signals at a different direction.

2. The active antenna array of claim 1, wherein each of the first antenna sub-array, the second antenna sub-array, and the plurality of middle antenna sub-arrays is configured to receive and transmit millimeter-wave radio signals.

3. The active antenna array of claim 1, wherein each of the first antenna sub-array, the second antenna sub-array, and the plurality of middle antenna sub-arrays is independently controlled.

4. The active antenna array of claim 1, wherein the plurality of middle antenna sub-arrays includes four antenna sub-arrays, each implemented in a different layer of the plurality of layers.

5. The active antenna array of claim 4, wherein two of the four antenna sub-arrays are implemented in a center of their respective middle layers, and the other two antenna sub-arrays are implemented in an edge of their respective middle layers.

6. The active antenna array of claim 5, wherein each of the two antenna sub-arrays implemented in the edge of a middle layer includes end-fire antenna elements.

7. The active antenna array of claim 1, wherein the multilayer substrate includes at least one ground layer, wherein the first antenna, the second antenna, and the plurality of middle antenna sub-arrays share the ground layer.

8. The active antenna array of claim 1, wherein each of the first antenna, the second antenna, and the plurality of middle antenna sub-arrays includes a number of radiating elements, wherein the number of radiating elements is greater than eight.

9. The active antenna array of claim 8, wherein a distance between each radiating element in the same antenna sub-array is between a half wavelength and a full wavelength of a millimeter-wave signal.

10. The active antenna array of claim 8, wherein the radiating elements of each of the antenna sub-arrays are at least printed on the substrate of their respective layer.

11. The active antenna array of claim 8, wherein each of the antenna sub-arrays is a phased array antenna.

12. The active antenna array of claim 11, wherein the millimeter-wave RF module further includes RF circuitry.

13. The method of claim 12, wherein the RF circuitry is configured to independently control the first antenna sub-array, the second antenna sub-array, and each of the plurality of middle antenna sub-arrays.

14. The method of claim 13, wherein the RF circuitry is further configured to control the phase per antenna in order to establish a beam-forming operation for the phased-array antenna.

15. The active antenna array of claim 12, wherein the millimeter-wave RF module further includes discrete electronic components providing a chip-board transition structure.

16. The active antenna array of claim 15, wherein the RF circuitry and the discrete electronic components are mounted on the front layer of the multi-layer substrate.
